(19) United States
(12) Patent Application Publication
(10) Pub. No.: US 2008/0093425 A1
(43) Pub. Date: Apr. 24, 2008

(54) Foldable Sheet Materials with Securement Means

(76) Inventor: George Wallace McDonald, Castel (GB)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 10/572,663

(22) PCT Filed: Sep. 8, 2004
(86) PCT No.: PCT/GB04/03833

§ 371 Date: Mar. 8, 2007

(30) Foreign Application Priority Data
Sep. 20, 2003 (GB) 0322098.5

(51) Int. Cl. B65D 27/00; B31B 49/00; B32B 7/00

(52) U.S. Cl. 229/68.1; 428/12; 428/68; 493/394

(57) ABSTRACT

The invention relates to a sheet material comprising a plurality of folds defining at least four segments, the sheet material being foldable and unfoldable about said folds, the sheet material comprising first and second securement means, arranged in use to cooperate to releasably secure the sheet material in the folded configuration when folded, and wherein the securement means are located such that the sheet material is foldable to a partially folded configuration comprising three columns of segments in a single row in which the first securement means is located on one outer column and the second securement means is located on the other outer column. The invention further relates to a sheet material comprising folds defining at least four segments arranged in at least three columns, the sheet material being foldable and unfoldable about said folds, the sheet material further comprising first and second securement means, arranged, in use, to cooperate to releasably secure the sheet material in the folded configuration when folded, the first and second securement means being located on separate columns spaced apart by one column.

### FIELD OF THE INVENTION

The invention relates to sheet materials and methods of locating sheet materials-on surfaces.

### BACKGROUND TO THE INVENTION

It is known to provide sheet materials which comprise a plurality of segments defined by folds in the sheet material. It may be desired, when the sheet material is folded about the folds into a folded configuration, to enable the folded sheet to be releasably secured in the folded configuration. Known means of securing folded sheets include the use of a separate adhesive strip, arranged to be connected to both the uppermost and lowermost segments in the folded sheet and secure them together, in order that the folded sheet remains folded. The adhesive strip may then be peeled off when desired in order to unfold the sheet.

One particular disadvantage with using adhesive strips is that once the strip has been used, and peeled off the folded sheet, the strip is generally unusable, or is reduced in effectiveness, for subsequent securement of the sheet, and a further strip may need to be utilised if it is desired to re-secure the sheet in the folded configuration. Furthermore the adhesive in adhesive strips may damage the sheet upon removal and may remove information located on the portion of the sheet to which it is attached.

Other ways of securing folded sheets in the folded configuration include the use of covers into which the folded sheet is deposited or the use of large cover portions connected to peripheral segments of the sheet material, which when the sheet is folded may cooperate to secure the sheet in the folded configuration. Such covers and cover portions can add to the expense of producing the sheet materials, and in some situations add relatively too much bulk to the sheet materials.

It would therefore be advantageous to provide securement means for foldable sheet materials, which means form part of one or more segments of the folded sheet, and which may be arranged to releasable secure the sheet material in the folded configuration. It would be further advantageous to provide a sheet material which could be releasably secured in the folded configuration by securement means formed from the segments of the sheet and which means could be reused a plurality of times if desired.

It would also be advantageous to provide a sheet material or sheet article which could be secured in a folded configuration, or simply folded, such that it can be passed through a mailing machine or the like for stamping, franking etc. without the folded material being damaged or coming apart.

It would be preferable to also provide a sheet article which comprises a single sheet of material that can be separated into a mailing portion and a portion that can either be inserted into the mailing portion, or part, or all of the portion retained by a user, and which preferably can be folded up securely to print mailing information on the mailing portion using conventional printing machines.

Generally, concertina folded sheet materials comprise a plurality of identically sized segments, which fold to form a neat stack, on which only the outermost top and bottom segments can be viewed by a user. This configuration is excellent for providing compact folded sheet materials, which have relatively low bulk and may be sized to fit in everyday articles such as pockets, wallets, credit-card wallets etc. However, many folded sheet materials provide information which is needed by a user only in part, but in order to view segments within the concertina folded stack, the entire concertina folded sheet must be unfolded in order to be able to view internal segments of the stack.

It would be advantageous to provide a concertina folded sheet material in which portions of internal segments may be viewable by a user even when the material is folded into a stack. It would furthermore be advantageous to provide a concertina folded material in which indicia is provided on each segment or some of the segments, which indicia may be viewable by a user when the concertina folded sheet material is in the fully folded configuration, in a stack.

Many sheet articles comprises covers to which is attached a sheet material which contains information in the form of, for example, a map or combined map and guide book. The maps generally include detailed street plans. It is desirable to include a key to the street plan on the sheet material in order that a user may determine, for example a particular road which they wish to know the location of on the map. Generally known sheet materials comprising guides or maps include a key to the guide or map on the same sheet material. It can be problematical for a user to review the map or guide, and cross reference desired information with the key on the same sheet of material, which key may be on the reverse of the material or on a folded portion of the material.

It would therefore be advantageous to provide a sheet article which comprises two or more sheet materials, on which, for example, a map or guide can be located on one sheet material, and a key to the map or guide located on a second sheet material, the sheet materials being arranged such that they may be viewed simultaneously or separately.

It would furthermore be advantageous to provide a sheet article comprising at least one concertina folded material and at least one further sheet material within a cover, which sheet materials may be located within the cover, and when the cover opened, the concertina folded sheet material can be opened to view information thereon.

It would also be advantageous to provide a sheet article that could be placed in an article such as a pocket, wallet etc and be easily retrieved from said article without a user having to delve into the article to grasp the sheet article.

It is therefore an aim of preferred embodiments of the present invention to overcome or mitigate at least one problem of the prior art, whether expressly disclosed herein or not.

### SUMMARY OF THE INVENTION

According to a first aspect of the invention there is provided a sheet material comprising a plurality of folds defining at least four segments, the sheet material being foldable and unfoldable about said folds, the sheet material comprising first and second securement means, arranged in use to cooperate to releasably secure the sheet material in the folded configuration when folded, and wherein the securement means are located such that the sheet material is foldable to a partially folded configuration comprising three columns of segments in a single row in which the first securement means is located on one outer column and the second securement means is located on the other outer column.

According to a second aspect of the present invention there is provided a sheet material comprising folds defining at least four segments arranged in at least three columns, the sheet material being foldable and unfoldable about said folds, the sheet material further comprising first and second securement means, arranged, in use, to cooperate to releasably secure the sheet material in the folded configuration when folded, the first and second securement means being located on separate columns spaced apart by one column.

By the term “column” we include a single segment or stack of segments, as well as a plurality of adjacent segments or stacks of segments separated by folds.

The folds preferably comprise a first set of parallel folds. The first set of parallel folds preferably comprises a plurality of folds in which the direction of the folds is the same with respect to the plane of the sheet material. Alternatively some or all of the folds may comprise concertina folds.

The sheet material may comprise one or more folds transverse to the first set of folds. Preferably the sheet material comprises a second set of parallel folds transverse to the first set of folds. Suitably the second set of folds is perpendicular to the first set of folds. The second set of folds preferably comprise folds in which the direction of the folds is the same with respect to the plane of the sheet, or some or all of the folds may be concertina folds.

The sheet material may comprise four or more columns of segments arranged in a single row.

Alternatively the sheet material may comprise three or more columns wherein at least one column comprises more than one row. There may be three or more columns wherein every column comprises a plurality of rows of segments. Suitably every column in the sheet material comprises the same number of rows.

In preferred embodiments the sheet material comprises four or more columns of segments arranged in a single row, or three or more columns of segments comprising a plurality of rows.

Preferably the first and second securement means are located on the same row when the sheet material comprises a plurality of rows. Thus the first and second securement means are preferably located spaced apart by exactly one segment in the sheet material, whether the sheet material comprises a single row or a plurality of rows of segments.

Preferably one of the first and second securement means are located on a segment at a corner of the sheet material, when the sheet is in the unfolded configuration. In this configuration the other of the first or second securement means is preferably located on a segment defined by an edge of the sheet material, spaced apart one column from the corner segment.

Alternatively one of the first and second securement means may be located on a segment defined by an edge of the sheet material and the other of the first and second securement means may be located on an interior segment of the sheet material, not comprising an edge of the sheet material.

The first and second securement means may both be located on interior segments of the sheet material.

The first securement means may comprise a male securement member and the second ,securement means may comprise a female securement member.

The male securement member may comprise a stud, plug or the like, arranged to cooperate with a female securement member in the form of a socket, for example.

Preferably the male securement member comprises a tongue arranged to cooperate with a female securement member in the form of a groove or slot. The tongue may extend from a segment edge or surface, or may extend from a fold defining a segment.

Preferably the securement means is located on a peripheral segment and the tongue extends from an edge therefrom.

The groove or slot is preferably formed into the surface of a segment. Alternatively the groove or slot may extend substantially at a fold defining a segment.

The first securement means may comprise an edge of a segment, arranged to cooperate with a second securement means, preferably in the form of a groove or slot into which at least a portion of the edge may be inserted.

The groove or slot may be as described above.

The segment comprising the edge functioning as the first securement means may comprise a narrower segment than the segment comprising the second securement means. Thus if the second securement means comprises a slot formed into the segment half-way along the segment surface, for example, the segment comprising the edge functioning as the first securement means may be substantially half the width of the second securement means segment, such that the distal end may cooperate with the slot.

The sheet material may comprise any suitable material, such as paper, card, plastics material and the like, or any mixture or combination thereof, for example.

The sheet material may comprise information or indicia located thereon, which may be located on one or more of the segments of the sheet material, and/or on the first and/or second securement means.

The sheet material may comprise a peripheral column of narrower width than the other columns of the sheet material, which narrower column preferably comprises the first securement means. Thus in use when the sheet material is in the folded configuration, the first securement means will be located uppermost or lowermost of the folded segments, adjacent to the second securement means, and at least a portion of the wider segment on which the second securement means is located, will be visible.

According to a third aspect of the invention there is provided a method of providing a folded sheet material to a surface, the method comprising the steps of:

a) providing a surface;

b) providing a sheet material of the first aspect of the invention; and

c) in any order, securing the sheet material in a folded configuration and locating the sheet material on the surface.

Preferably step c) comprises securing the sheet material in the folded configuration and then locating the secured sheet material on the surface.

The method, in step c) may comprise connecting the sheet material to the surface.

Preferably the method comprises locating adhesive to either or both of the surface and sheet material and step c) includes adhering the surface to the sheet material.

Suitably the surface is a sheet article, and preferably the sheet article is a sheet article comprising a plurality of leaves of sheet material, and may be a book, booklet, magazine, pamphlet or the like, for example. Step c) may comprise connecting the sheet material to an outer leaf or outer cover of the sheet article comprising a plurality of leaves. Alternatively the sheet article may be a sheet cover, such as a card cover, for example.

According to a fourth aspect of the invention there is provided a sheet material comprising an envelope portion comprising-a pocket and a pocket closure flap; and a sheet portion comprising a first set of folds defining a plurality of segments, detachably connected to the pocket closure flap.

The first set of folds is preferably a first set of concertina folds.

The sheet portion is preferably integrally formed with the envelope portion.

The sheet portion may comprise a second set of folds, transverse to the first set of folds. Preferably the second set of folds is a set of concertina folds.

The sheet portion may be connected to the closure flap in any suitable configuration, but is preferably connected to the free, distal edge of the closure flap.

Preferably the sheet portion is connected to the closure flap at a line of weakness, such that the sheet material can be detached from the closure flap at said line of weakness in use. The line of weakness preferably comprises a line of perforations.

The sheet portion may comprise segments having a length equal to, longer or shorter than the length of the pocket and/or closure flap.

The closure flap preferably comprises a pocket sealing means, arranged in use to seal the pocket closure flap over the opening of the pocket.

The pocket sealing means may comprise an adhesive. The adhesive may comprise a material for which wetting of the material activates the adhesive, such as adhesive gum, for example. Alternatively the adhesive may comprise a detachable cover, arranged to prevent adhesion of the adhesion to the pocket until the cover is removed.

Suitably the sheet material is substantially credit-card sized, such that it may be retained in a pocket or wallet of a user.

According to a fifth aspect of the invention there is provided a sheet material comprising a first set of parallel folds, defining a plurality of segments, about which folds the sheet material can be unfolded and folded, the first set of folds comprising at least two concertina folds, a plurality of the segments being foldable about said concertina folds to form a stack, and wherein the sheet material comprises at least one segment which, in use, is foldable over the folded stack to form a cover portion thereon.

Preferably the segment or segments comprising the cover portion effect provision of a solid spine extending substantially along a side of the stack of segments, when the cover portion is folded over the stack, in use.

The cover portion may comprise a single segment or a plurality of segments, which may comprise a plurality of concertina-folded stacked segments.

The sheet material may comprise one or more folds transverse to the first set of folds. The sheet material is preferably foldable about the one or more transverse folds, such that it can be folded into a single row of stacked segments defined by the first set of folds. Thus when the sheet material is folded about the one or more transverse folds it can then be concertina-folded about the concertina folds in the first set of folds and the cover portion folded over the stack.

Preferably the one or more transverse folds comprises a second set of parallel folds, more preferably a set of concertina folds.

Suitably the sheet material, in the folded configuration is substantially credit-card sized.

The sheet material may comprise paper, card, plastics material or any other suitable flexible material, for example.

According to a sixth aspect of the present invention there is provided a sheet material comprising a first set of concertina folds defining a plurality of segments, the sheet material being foldable about the folds to form a stack of segments, and wherein the folds are positioned such that when the segments are folded into a stack, a plurality of the segments present a marginal portion.

Preferably the sheet material comprises a first set of concertina folds defining a row of segments, wherein the folds are positioned such that an outermost segment of the row has a first size, and a plurality of subsequent segments have a width or length larger than the previous largest upstream segment in the row of segments. Preferably at least 50% of the segments comprises a width or length larger than the previous largest upstream segment in the row. Suitably the other outermost segment of the row comprises the segment with the largest width or length.

In particularly preferred embodiments, an outermost segment in the row has a first, smallest width or length and a plurality of downstream adjacent segments continuous from the first segment each comprise a width or length larger than its previous upstream adjacent segment. In some embodiments all of the segments in the row may comprise a width or length larger than its adjacent upstream segment. Thus in these embodiments, when the row of segments is folded in a stack the outermost smallest segment will be presented uppermost or lowermost in the stack and each subsequent adjacent segment having a larger width or length than its previous adjacent segment or the previous largest upstream segment, will present a marginal portion viewable and/or graspable by a user. Thus a user may grasp the marginal portion of a segment and open the sheet material at that segment to view the downstream adjacent segment quickly and easily.

The marginal portion of one or more of the segments may be provided with indicia, such as printed information or the like, which indicia may be linked with indicia provided on the non-marginal portion of the said segment and/or another segment or segments. Thus a user requiring to view the indicia on a non-marginal portion simply needs to find the corresponding indicia a marginal portion and open the stack of segments at said marginal portion to arrive at the desired indicia on the desired segment or segments.

The sheet material may comprise a stiff portion connected to an outermost segment of the sheet material; preferably the outermost segment at the other end of the sheet material to the said first outermost segment.

The sheet material may comprise a second set of folds or a single fold, transverse to the first set of folds. Preferably the second set of folds is a set of concertina folds.

According to a seventh aspect of the invention there is provided a sheet article comprising a cover and at least two sheet materials fixedly connected to the cover, wherein at least one of the sheet materials comprises concertina folds, and wherein the cover comprises at least a first portion and a second portion arranged in use to enable sandwiching of at least one of the sheet materials between said portions.

Preferably the sheet materials are connected to different surfaces of the cover.

Preferably the sheet materials are connected to the inside of the cover.

The sheet material comprising concertina folds may comprise a single set of concertina folds defining segments in the sheet. The single set of folds may define a single row of segments in the sheet material. Preferably however the sheet material comprising concertina folds comprises a first set of concertina folds and, transverse to the first set of concertina folds, a fold or a second set of concertina folds. Thus whether the material comprises a single set of concertina folds or two sets of concertina folds the sheet material may be folded up about the folds into a stack of folded segments.

When the sheet material comprising concertina folds comprises two sets of transverse folds preferably the sheet material is fixedly connected to the cover at or near a corner of the sheet material.

When the sheet material comprising concertina folds comprises a single set of folds defining a single row, then preferably the sheet material is fixedly connected to the cover at or near an end segment of the sheet material.

The sheet material comprising concertina folds may comprise a means to facilitate folding and unfolding of the sheet material, in use.

The means to facilitate opening and closing of the sheet material may comprise a stiff portion connected to the sheet material. If the sheet material comprises first and second sets of concertina folds, preferably the stiff portion is located at or near a corner segment of the sheet material, more preferably a corner segment which is an outer segment of the stack of segments when the sheet material is folded. Suitably the sheet material comprising concertina folds is connected to the cover at or near a corner of the sheet material and the stiff portion is located at or near the diagonally opposite corner of the sheet material thereto. If the sheet material comprises a single set of concertina folds in a single row then preferably the stiff portion is located at an end segment of the sheet material. Suitably, when the sheet material comprises a single set of concertina folds defining a single row, then preferably the sheet material is connected to the cover at or near an end segment of the sheet material.

Suitably the stiff portion is constructed from paper, card, plastics or the like. The stiff portion may include a transparent portion, which enables viewing of the segment beneath the stiff portion. Alternatively the stiff portion may comprise a transparent stiff portion. The stiff portion may be connected to the sheet material by any suitable means for example by an adhesive or by heating sealing techniques.

Suitably the stiff portion is located on the outside of the sheet material when it is in the folded configuration.

A stiff portion may be provided by a segment of the sheet material comprising concertina folds which has been treated to make it stiffer than the remaining segments of the sheet.

For example, a segment may be soaked in a UV-curable resin and then cured to provide a stiff portion.

Suitably, when the sheet material comprising concertina folds comprises two transverse sets of concertina folds one set of folds comprises an odd number of folds and the other set of folds comprises an even number of folds. Alternatively both sets of folds may comprise an odd number of folds, or both may comprise an even number of folds.

The first and second portions of the cover are preferably rotatably connected. Thus the first and second portions may be rotated about a connection towards and away from each other.

The first and second surfaces are preferably of the same size but may be of different sizes.

The cover may comprise a surface separated into the first and second portions by a fold line. Thus the fold line provides a rotatable connection about which the first and second portions are able to rotate.

Alternatively the cover may comprise separate rotatably connected first and second portions. The first and second portions may be connected by way of a hinge. The first and second portion may be connected by stitching, or the like, which stitching is arranged to allow relative rotation of the first and second portions.

The cover may comprise further portions in addition to the first and second portion. Each portion is preferably rotatably connected to its adjacent portion or portions. Preferably each portion is formed from a single surface separated into portions by a plurality of fold lines. Alternatively each portion may be a separate portion rotatably connected to its adjacent portion or portions, by way of a hinge or the like, for example.

In some embodiments the cover may comprise a book-cover configuration comprising first and second portions rotatably connected either side of a spine, the spine preferably being of smaller width than the first and second portions. Suitably the first portion, second portion and spine are formed on a single member and separated by fold lines in the member.

At least one of the sheet materials fixedly connected to the cover preferably comprises a plurality of leaves, in the form of a booklet. The booklet may comprise leaves of identical size, or a plurality of leaves in the booklet may comprise different sizes. In preferred embodiments, some or all of the leaves may be of different sizes such that a plurality of the leaves present a marginal portion which can be viewed by a viewer without opening the booklet. All the leaves may comprise different sizes arranged such that all the leaves present a marginal portion. Alternatively the booklet may comprise a plurality of sections comprising at least one leaf per section, the sections being separated by a leaf having a different size to the leaves in an adjacent section or sections. The leaves may differ in length, width or both length and width.

A booklet may be provided by connecting individual leaves to the cover. Thus the leaves of the booklet may not be connected to each other nor may it comprise a spine. The leaves may be connected to the cover spaced apart to provide a marginal portion of each leaf when the booklet is closed. Alternatively the booklet may comprise a plurality of smaller booklets connected to the cover, which plurality of smaller booklets may be connected together or be separate.

The leaves of the booklet may comprise at least one cover portion connected to an outermost leaf of the booklet. Preferably the cover portion comprise a portion stiffer than the leaves of the booklet. Preferably the cover portion comprises a larger size than the leaves of the booklet, such that the cover portion overhangs at least one edge of the largest leaf in the booklet; more preferably it overhangs at least two edges and preferably it overhangs three edges.

Suitably the booklet is connected to the cover of the sheet article at or near the spine of the booklet. Alternatively the booklet may be connected to the cover of the sheet article at an outermost leaf of the booklet.

Preferably at least one of the sheet materials comprises a sheet material of the sixth aspect of the invention. Suitably the sheet material is connected to the cover such that the first, outermost segment is located outermost from the cover when the sheet material is folded into the stack.

According to an eighth aspect of the invention there is provided a sheet article comprising a cover to which is connected a sheet material comprising concertina folds, the sheet material being foldable and unfoldable about said folds, wherein the cover comprises a first portion and a second portion arranged to enable sandwiching of the folded sheet material between said portions, and wherein the cover further comprises a handle portion protruding from the cover.

The first and second portions are preferably rotatably connected. Suitably the first and second portions are rotatably connected about a common axis, which may comprise a hinge, fold line or the like, for example.

Preferably the first and second portions comprise first and second substantially planar surfaces.

The first and second portions are preferably formed from a surface divided into the first and second portions by a fold, about which fold the first and second surfaces are relatively rotatable.

The handle portion may protrude from the first portion or second portion.

The handle portion may protrude from an edge region of the cover, or transverse from a surface of the first or second portions.

Preferably, however the handle portion protrudes from or near the rotatable connection between the first and second portions. In the case of the first and second surfaces being rotatably connected by a fold therebetween, preferably the handle portion protrudes from or close to the fold.

The handle portion may be movably mounted on the cover, preferably rotatably mounted. Alternatively the handle portion may be rigidly connected to the cover, or integrally formed with the cover.

Preferably the handle portion is arranged to be co-planar or parallel with the first or second portions regardless of the relative orientation of the first portion and second portion.

The handle portion may be connected to the first portion and orientated so that it is parallel with the first portion and extends beyond the rotatable connection between the first and second portions. Thus when the first and second portions are co-planar the handle portion abuts the second portion in the region near the connection, but when the first and second portions are rotated towards each other the handle portion extends beyond the rotatable connection from the first portion and thus presents a handle for a user to grasp.

The second portion may comprise a cut-out section at or near to the rotatable connection between the first and second portions, and the handle portion may comprise a part of the first portion that extends at least partly into the cut-out of the second portion when the portions are co-planar. Thus when the first and second surfaces are rotated about the rotatable connection, the handle portion may be presented out of the cut-out section, co-planar with the first portion.

Preferably the handle portion is integrally formed with the first portion of the cover. Alternatively the handle portion may be connected, to the first portion.

Suitably the first and second portions are substantially credit-card sized.

The cover may be constructed from paper, card, plastics or any mixture thereof, for example.

The sheet material comprising concertina folds is preferably as described hereinabove for the other aspects of the invention.

The cover may comprise one or more further sheet materials, which may comprise concertina folds or not. The one or more further sheet materials may be connected to the first portion, second portion or both portions, for example. The further one or more sheet materials may be a sheet material as described for any of the aspects of the invention described hereinabove.

### BRIEF DESCRIPTION OF THE DRAWINGS

For a better understanding of the invention and to show how embodiments of the same may be put into effect, the various aspects of the invention will now be described by way of example only with reference to the accompanying drawings in which:

FIG. 1A illustrates a plan view of a sheet material of the invention;

FIG. 1B illustrates a side sectional view through the line A-A of FIG. 1A, when the sheet material has been folded and secured in the folded configuration;

FIG. 2A illustrates a plan view of a second embodiment of a sheet material of the invention;

FIG. 2B illustrates a plan view of the embodiment shown in FIG. 2A partially folded;

FIG. 2C illustrates a side view of the partially folded sheet material shown in FIG. 2B;

FIG. 3 illustrates a plan view of a third embodiment of a sheet material of the invention;

FIG. 4 illustrates a plan view of a fourth embodiment of a sheet material of the invention;

FIG. 5 illustrates a plan view of a fifth embodiment of a sheet material of the invention;

FIG. 6 illustrates a plan view of a sixth embodiment of a sheet material of the invention;

FIG. 7 illustrates a plan view of a first embodiment of a sheet material of the fourth aspect of the invention;.

FIG. 8 illustrates a plan view of a second embodiment of a sheet material of the fourth aspect of the invention;

FIG. 9 illustrates a first embodiment of a sheet material of the fifth aspect of the invention;

FIG. 10A illustrates ,a plan view of the embodiments shown in FIG. 9 in a partially folded configuration;

FIG. 10B illustrates a side view of the partially folded configuration of FIG. 10A;

FIG. 11 illustrates a side view of the sheet material of FIG. 9 in a fully folded configuration;

FIG. 12 illustrates a second embodiment of a sheet material of the fifth aspect of the invention;

FIG. 13A illustrates a first embodiment of a sheet material of the sixth aspect of the invention in plan view;

FIG. 13B illustrates a side view of the embodiment shown in FIG. 13A, partially folded into a stack.

FIG. 13C illustrates a plan view of the embodiment shown in FIGS. 13A and 13B, folded into a stack.

FIG. 14 illustrates a plan view of a first embodiment of a sheet article of the seventh aspect of the invention in a partially opened configuration;

FIG. 15 illustrates a plan view of a second embodiment of a sheet article of the seventh aspect of the invention;

FIG. 16A illustrates a plan view of a preferred embodiment of a sheet article of the eighth aspect of the invention, in which the cover of the sheet article is unfolded;

FIG. 16B illustrates the sheet article of FIG. 16A in side perspective view from one side of the article, in which the cover has been almost completely folded to sandwich the sheet material within the cover; and

FIG. 16C illustrates the sheet article of FIG. 16B in side perspective view from the other side of the cover.

### DESCRIPTION OF THE PREFERRED EMBODIMENTS

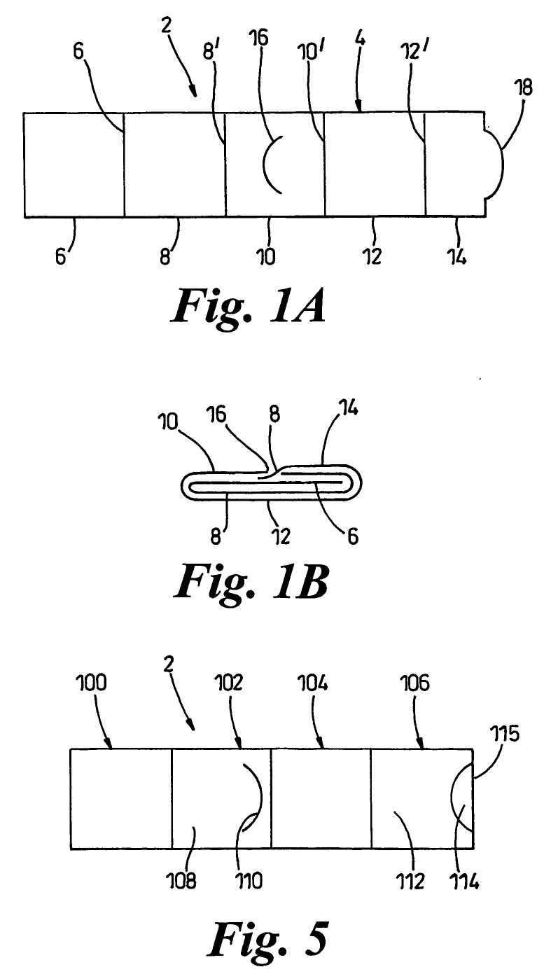

We turn firstly to FIGS. 1A & 1B which illustrate a first embodiment of a sheet material of the first aspect of the invention. The sheet material 2 comprises five sequential segments 6,8,10,12,14, defined by fold lines 6′,8′,10′,12′. The segments, 6,8,10,12,14 define five columns having a single segment in each column, and hence define a single row. The outermost segment 14 is narrower than the other segments, corresponding to half the width of the other segments. The segment 14 comprises a first segment which includes a first securement means in the form of a tongue 18 formed from and protruding from the distal edge of the segment 14. The middle segment 10 forms a second segment comprising a second securement means in the form of a slot 16 located substantially halfway across the segment 10. Thus the first segment 14, being an outermost segment of the sheet 4, and the second segment 10, being the middle segment of the five segments of the sheet 4, are spaced apart by a single segment, segment 12.

Use of the sheet material 2 of FIGS. 1A and 1B will now be described. When it is desired to fold up the sheet 4 and secure the sheet in the folded configuration, firstly the outer segment 6 is folded onto the segment 8, and the stack of segments 6,8 folded onto the segment 10. The stack of segments 6,8,10 is then folded onto the segment 12. In this orientation the segment 10 is uppermost in the stack of segments 6,8,10,12. The first segment 14 is then folded onto the stack of segments 6,8,10,12 such that it lies adjacent to the uppermost segment 10 on the stack, as shown in FIG. 1B. In this position the tongue 18 on the segment 14 can be slotted into the slot 16 located halfway along the segment 10, due to the segment 14 being only half the width of the segment 12. Thus the stack 6,8,10,12,14 is secured in the folded configuration. When it is desired to unfold the sheet 4, a user simply removes the tongue 18 from the slot 16 and unfolds the segments 6,8,10,12,14 in the reverse order to that described hereinabove for the folding sequence of the sheet 4.

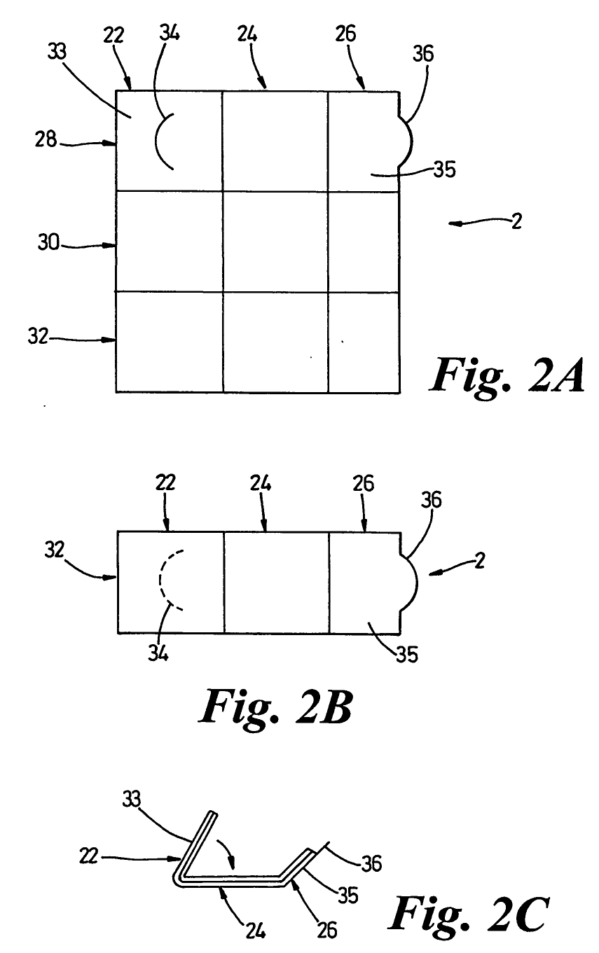

We turn now to FIGS. 2A-2C which illustrate a second embodiment of a sheet material 2 of the invention. FIG. 2A illustrates a plan view of the sheet material 2 in the fully unfolded configuration. FIG. 2B illustrates a plan view of the sheet material in a part folded configuration and FIG. 2C illustrates a side view of the sheet material 2 in an almost fully folded configuration.

The sheet material 2 shown in FIGS. 2A-2C comprises three columns 22,24,26 and three rows 28,30,32, defining 9 segments. The right peripheral column 26 is narrower than the left and centre columns 22,24, and includes at the upper-right segment 35, a first securement means in the form of a tongue 36. The upper left corner segment 33 defined by the left-hand column 22 and the top-most row 28 includes a second securement means in the form of a slot 34. Thus the slot 34 and tongue 36 are spaced apart by one column, being the centre column 26.

The sheet material 4 its folded by firstly folding the lower-most row 32 onto the centre row 30 and then folding the stacked rows 32,30 onto the upper row 28, to give a partially folded configuration as shown in FIG. 2B, in which the slot 34 is lowermost in the stack. The left hand column 24 is then folded onto the centre column 26 such that the slot 34 is now present uppermost on the stack. The right hand column 26 is then folded over onto the stack of columns 22,24 and the tongue 36 slotted into the slot 34 to secure the sheet material in the folded configuration.

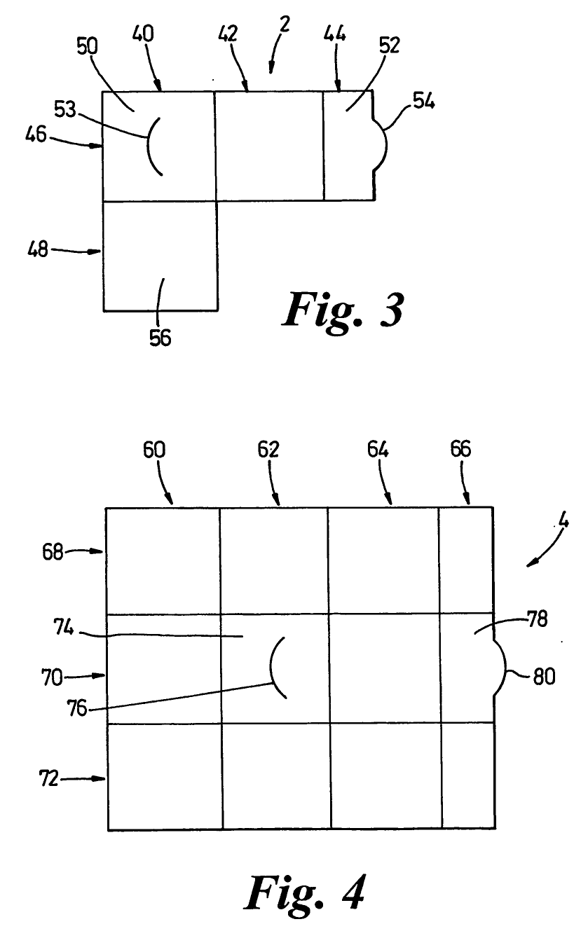

We turn now to FIG. 3, which illustrates a third embodiment of a sheet material 2 of the invention. In this embodiment the sheet material comprises a left-hand column 40, centre column 42 and right hand column 44. The left hand-column comprises two rows 46, 48, thus defining a single segment 56 in the lower row 48. The other columns 42,44 comprise only a single row 46. All segments within the rows and columns are defined by folds in the sheet material 4, as described hereinbefore. The upper row 46 comprises a segment 50 on the left-hand column 40 which includes a slot 53. The only segment 52 in the right hand column 44 comprises a tongue 54 and is of narrower width than the segments of the left 40 and centre 42 columns. Use of the sheet article 4 of FIG. 3 is similar to that described for FIG. 1, except the single segment 56 in the lower row 48 of the left hand column 40 is folded firstly onto the upper row 46 of the left hand-column (specifically onto the segment 50 comprising the slot 52), then the left-hand column 40 folded onto the centre column 42, before the right-hand column 44 is finally folded onto the stack of columns 40,42.

We turn now to FIG. 4 which illustrates a fourth preferred embodiment of a sheet material 4 of the invention. The sheet material 4 is similar to that shown in FIG. 2A, including first 60, second 62, third 64 and fourth 66 columns and top 68, centre 70, and bottom 72 rows defining 9 segments. The right hand column 66 is of narrower width than the other two columns. In this embodiment a first securement means in the form of a tongue 80 is present on the segment 78 located on the centre row 70 and right hand column 66. A second securement means comprising a slot 76 is located at the segment 74 defined in the centre row 70 and second column 62, and is thus separated by one column from the column 66 comprising the tongue 80. In this embodiment the top row 68 is firstly folded onto the centre row 70, then the bottom row 72 folded onto the stack of rows 68,70. The first column 60 is then folded onto the second column 62, the stack of columns 60,62 is then folded onto the third column 64 and the fourth column 66 folded onto the stack 60,62,64 and the tongue 80 is inserted into the slot 76.

We turn now to FIG. 5 which illustrates a fifth embodiment of a sheet material 2 of the invention. The sheet material comprises four sequential columns 100,102,104,106 of equal width. A first securement means in the form of a tab 114 is located protruding from the distal edge 115 of the segment 112 located on the fourth column 106. A second securement means in the form of a slot 110 is present on the segment 108 defined in the second column. Thus the securement means and segments to which they are located are separated by exactly one column (the third column 104). In use the first column 100 is folded onto the second column 102 and the resultant stack folded onto the third column 104, such that the slot 110 is facing uppermost out, of the stack. The fourth column 106 is then folded onto the stack and at the same time the tab 114 is tucked into the slot, to secure the resultant fully folded sheet in the folded configuration. The fourth column 106 may alternatively be folded beneath the stack and the tab 114 folded round the stack and tucked into the slot 110 to secure the sheet material 2 in the folded configuration.

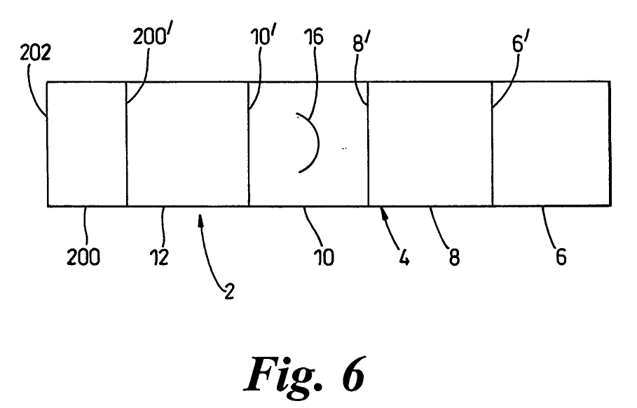

We turn now to FIG. 6 which illustrates a sixth embodiment of a sheet material 2 of the invention. The sheet material 2 is very similar to that described for FIGS. 1A and 1B and like numerals represent like components.

In the embodiment shown in FIG. 6, the first securement means comprises a distal edge 202 of one of the peripheral segments 200 of the sheet material. As in the embodiment shown in FIG. 1, the middle segment 10 comprises the second securement means in the form of a slot 16 located substantially half-way across the segment 10. The segment 200 which comprises the first securement means 202 has a narrower width than the remaining segments 6,8,10,12 of the sheet material 2.

Use of the sheet material to FIG. 6 is very similar to the use described for FIG. 1, except that the distal edge 202 of the segment 200 is slotted into the slot 16 of a middle segment 10 when the sheet material 2 is folded. When it is desired to unfold the sheet 4, a user simply removes the distal edge 202 from the slot 16 and unfolds the segment 6,8,10,12,200 in reverse order to how they were folded.

The embodiment shown in FIG. 6 provides the extra advantage of not involving formation of any shaped first securement means, as the distal edge 202 can simply be formed by producing a segment 200 which is the same size as the other segments of the sheet material, and cutting the segment 200 to a desired width.

In all of the embodiments described hereinabove the resultant folded and secured sheet material may be placed in a sheet article, such as a book, booklet, pamphlet, magazine and the like for example. Alternatively the folded and secured sheet material 2 may be adhered to the article by the opposite segment in the folded stack to the segments comprising the connected securement means, thus enabling a user to unfold and fold the sheet material 2 as and when desired on the sheet article. The sheet material 4 may be adhered to the sheet article by a low-tack adhesive such that the sheet material 4 may be removed from the sheet article if desired by a user.

We turn now to FIG. 7 which illustrates a first embodiment of the fourth aspect of the present invention. FIG. 7 shows a sheet article 300 comprising an envelope portion 302 comprising a pocket 304 and a pocket closure flap 306. The sheet article 300 further comprises a concertina-folded portion 308 comprising a plurality of segments 310A to 310E defined by a first set of concertina folds 311A to 311D, in a single row 309. The plurality of segments 310A to 310E is detachably connected to the pocket closure flap 306 via a perforated line of weakness 312 joining an edge of, the segment 310A to the pocket closure flap 302. The pocket closure flap 302 includes an adhesive strip 314, which comprises a material which, when wetted, activates to become adhesive. The pocket 304 includes at the pocket opening edge a cut-out 315, enabling a user to more easily grasp the edge of the pocket in order to insert or remove items from the pocket 304.

In use, the segments 310A to 310E defined by the concertina-folds 311A to 311D can be printed with any suitable information or indicia. Furthermore, the reverse side of the envelope portion 302 can be printed with the name and address of a suitable recipient for the envelope portion 302. In preferred embodiments the segment 310A to 310E, defined by the concertina-folds 311A to 311D may comprise a questionnaire, or order form, for example, which a user may fill in, and tear off at the line of weakness 312. The thus torn off concertina portion 308 may then be folded about the concertina-folds 311A to 311D, to form a stack of segments, and inserted into the pocket 304 of the envelope portion 302. Once the stack of segments 310A to 310E is inserted into the pocket 304, the adhesive material 314 on the pocket closure flap 306 can be wetted, and the pocket closure flap 306 folded over onto the front of the pocket 304, where the wetted material 314 adheres to the pocket 304 to securely close the envelope portion 302. The secured envelope portion 302, containing the stack of segments 310A to 310E may then be posted or mailed to the recipient indicated on the front of the pocket 304. Alternatively if no recipient is printed on the front of the pocket 304, a user may write a suitable name and address of a person for whom it is intended to post the article 300.

An advantage of using the single sheet article 300 of FIG. 7 is the cost saving in producing the article, which can be manufactured from a single sheet of material and manipulating by introducing fold lines and gluing the pocket 304 into the pocket configuration, simply and easily, without the need to apply more expensive cover portions, with their associated increase in labour to manufacture.

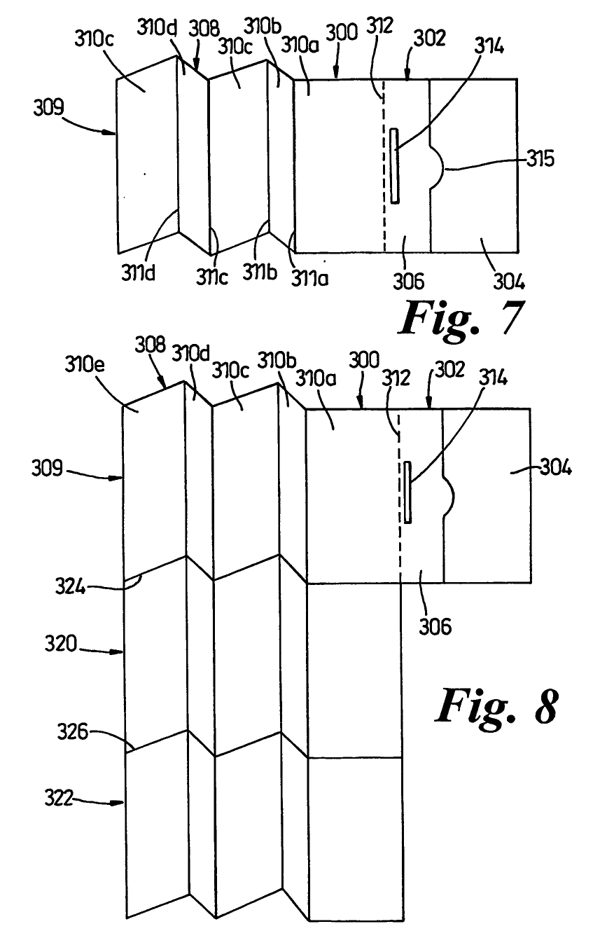

We turn now to FIG. 8 which illustrates a second embodiment of the sheet article of the fourth aspect of the invention. The sheet article 300 is very similar to that shown in FIG. 7, and like numerals represent like components.

The sheet article 300 of FIG. 8 includes an envelope portion 302 from which extends a plurality of segments 308 defined by concertina folds. The plurality of segments 308 are arranged in five columns 310A to 310B and three rows 309, 320 and 322, separated by fold lines 324 and 326. The fold lines 311A to 311D, and 324 and 326 are alternately facing towards and away from the front of the segments 308, in order to provide concertina folds. The plurality of segments 308 are connected to the pocket portion 304 at the upper right segment 310A by way of a perforated line of weakness 312, about which line the envelope portion 302 and plurality of segments 308 can be detached.

Use of the sheet material 300 shown in FIG. 8 is substantially the same as used to describe FIG. 7 above, except that firstly the rows 309, 320 and 322 are concertina folded up to provide a single stacked row adjacent to the envelope portion 302. The single stack row may then be concertina folded transversely to the folding of the original three rows, in order to provide a stack of single segments, as described for the embodiment shown in FIG. 7.

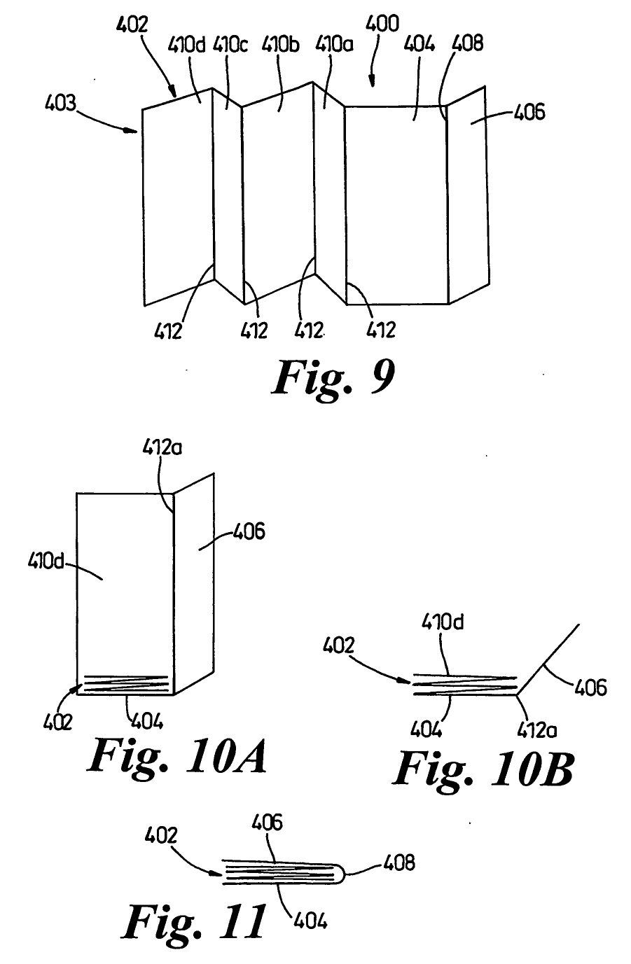

We turn now to FIGS. 9, 10A, 10B and 11, which illustrate a first embodiment of a sheet material of the fifth aspect of the invention. The sheet material 400 comprises a set of parallel folds 412A to 412D defining a plurality of segments in a single row. The folds 412A to 412D are concertina folds extending alternately towards and away from the plane of the sheet material 400. At one end of the concertina folded defined segments 402 is a base segment 404, integrally formed with the segment 410A, and separated by the fold line 412A. At the opposite edge of the base segment 404 to the fold line 412A, a cover segment 406 is integrally formed about a fold line 408. The fold line 408 is folded such that the segment 406 is foldable in the same direction as the segment 410A. Thus the fold line 408 and 412A fold in the same direction.

In use, the concertina fold defined segments 410A to 410D can be folded up about the fold lines 412A to 412D, to form a stack of segments. The stack can then be folded about the fold line 412A on the base segment 404 as shown in FIGS. 10A and 10B. In this position, the sheet material comprises a stack comprising base segment 404 and the concertina fold-defined segments 410A to 410D, and extending from one edge of the base segment 404 is the cover segment 406, as shown in FIGS. 10A and 10B. In order to secure the sheet material in a folded stack, the cover segment 406 can then be folded about the fold line 408 on top of the stack of concertina fold-defined segments 402, forming a cover portion thereon. In this position, as can be seen in FIG. 11, a solid spine is also formed along one side of the concertina folded stack 402, the spine being in the form of the fold line 408 which extends around one side of the concertina fold stack 402.

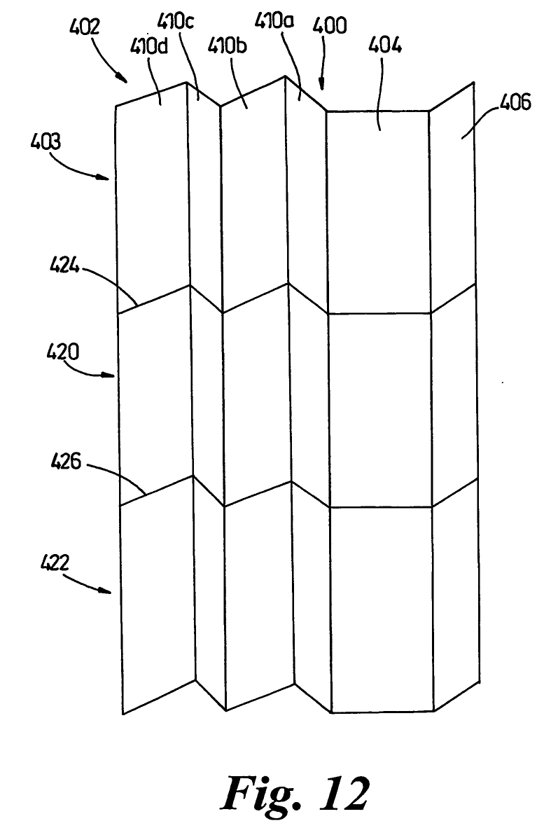

We turn now to FIG. 12 which illustrates a second embodiment of a sheet material 400 of the fifth aspect of the invention.

The embodiments shown in FIG. 12 is very similar to that shown in FIG. 11, and like numerals represent like components. In the embodiment shown in FIG. 12, the sheet material 400 comprises three rows of segments, 403, 420, 422, each row being identical to the row 403 described for the embodiment of FIG. 11. The rows are integrally formed from the same sheet material 400, and separated by fold lines 424 and 426. The fold lines 424 and 426 are alternately extending into and away from the plane of the sheet material, and thus are concertina folds. In use, folding up of the sheet material 400 is very similar to the mechanism described for the embodiment of FIG. 11, except that firstly the rows 403, 420 and 422 are concertina folded up to form a single stacked row of segments corresponding to the single row 403. Subsequent folding of the sheet material into a single segment stack is identical to that described for the embodiment of FIG. 11. In this embodiment, the use of extra rows of segments enables a manufacturer or user to incorporate far more information on a single sheet material 400, than would be possible with the embodiment of FIG. 11, but the sheet material 400 of the embodiment shown in FIG. 12 can be folded up to a substantially similar size to that shown in the embodiment of FIG. 11, and thus does not suffer any disadvantages in bulk for a user to contend with.

The use of a cover segment 406 or cover segments 406 in FIGS. 11 and 12 and the embodiments shown for the fifth aspect of the invention enables a concertina folded sheet material to be folded up to a single stack of superposed segments, over which an integral segment cover may be folded to provide a solid spine along one edge thereof, which then enables the folded stack to be passed through, for example, printing or mailing machines in order to be printed on or stamped/franked, without free edges of the stack being present in the forward portion of the stack as it enters the machine; the solid spine formed by the cover portion can be arranged to enter the machine first, in order that the stack remains folded within the machine and does not catch or tear in the mechanism of any printing or mailing machine.

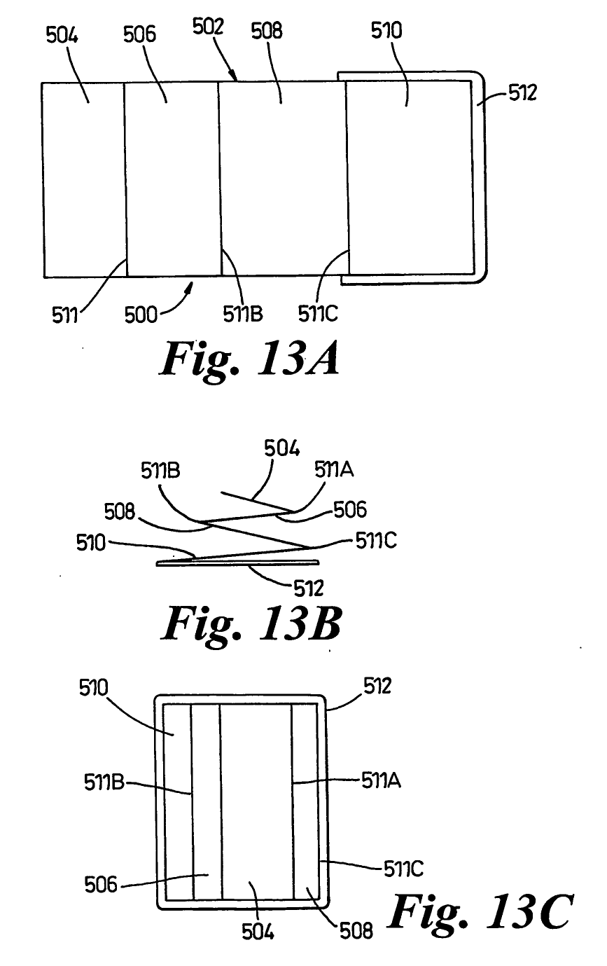

We turn now to FIGS. 13A, 13B and 13C which illustrate a first embodiment of a sheet material of the sixth aspect of the invention.

The sheet material 500 comprises a sheet 502 which includes a first set of fold lines comprising concertina folds, in the form of folds 51A, 51B and 51C which folds alternate in direction with respects to the sheet 502. The folds 51A to 51C define a plurality of segments 504, 506, 508, 510. The fold 51A to 51C are located along the sheet 502 such that the outmost segment 504 is the smallest segment in width, and each segment downstream from segment 504 has an increasing width. Thus segment 504 has the smallest width, adjacent segment 506 has a larger width than segment 504, segment 508 has a larger width than segment 506 and the segment 510, the other outermost segment of the row, has the largest width of all the segments.

Connected to one side of the largest segment 510 is a stiff card portion 512 which has dimensions slightly longer and wider than the segment 510. We turn now to FIGS. 13B and 13C which show use of the sheet material 500. The sheet 502 is folded about the concertina fold 51A to 51C as shown in side view in FIG. 13B. The largest segment 510 is. folded flat against the cover 512, and the segment 508 is folded down onto the segment 510, the segment 506 is folded onto the segment 508 and the outermost smallest segment 504 folded onto the segment 506.

As can be seen from FIG. 13C, when the sheet 502 is folded into a stack, a marginal portion of each of segments 510, 508 and 506 can be seen in the stack, and the entire segment 504 can be seen on top of the stack in the outermost position.

In the sheet material as shown in FIG. 13A to 13C, a user may view information printed or connected to the marginal portions of segments 506, 508 and 510 and information printed or connected to the segment 504, to decide which segment the sheet 502 is the desired segment to unfold. The user may then grasp the marginal portion of any of the segments, or grasp the full segment 504, and unfold the sheet at said segment to display information on the underside of the adjacent segment below the said segment, and also view information on the segment two segments away. Thus for example, if a user grasped the marginal portion of segment 506 at the fold line 511B, and unfolded the sheet material about fold 511C by rotating about the fold line 511C using the fold line 511B as leverage, a user may then see the underside of segment 508 and the top side of segment 510. Of course a user may grasp the segment 504 and unfold as many segments as he or she desires, including unfolding all of the segments to provide a substantially planar sheet material as shown in FIG. 13A.

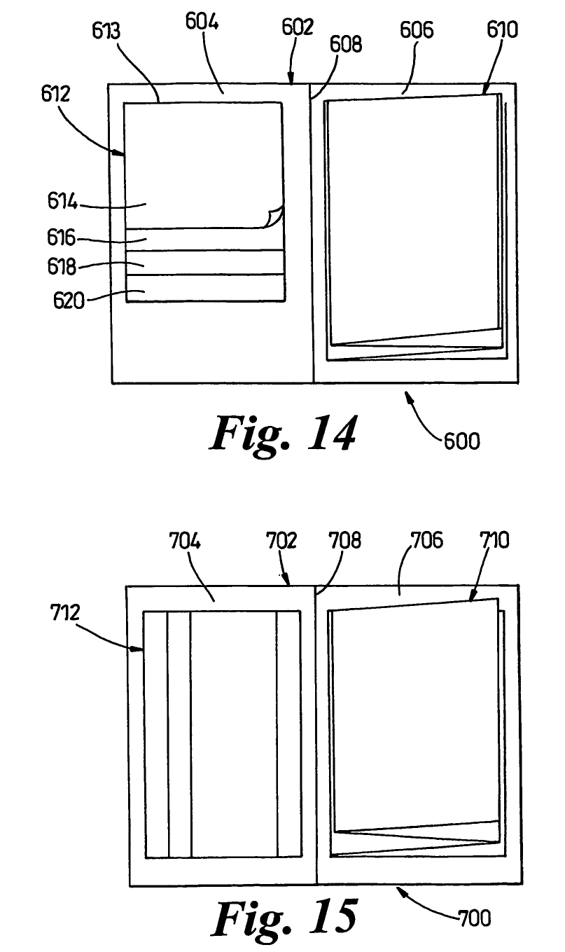

We turn now to FIG. 14 which illustrates a first embodiment of a sheet material 600 of the seventh aspect of the invention.

The sheet article 600 comprises a cover 602 which comprises a first portion in the form of a first surface 604, and a second portion in the form of a second surface 606, rotatably connected about a fold line 608. Thus the first and second surfaces 604 and 606 are formed from the same surface, and only separated by a fold line 608.

Attached to the inside of the second surface 606 is a concertina folded sheet material 610. The concertina folded sheet material may comprise only a first set of folds comprising concertina folds or may comprise a first set of folds comprising concertina folds and a second set of folds transverse to the first set of folds, the second set of folds being concertina folds or otherwise.

Connected to the inside of the first surface 604 is a booklet 612 in the form of a plurality of sheets 614, 616, 618 and 620, each connected to a spine 613, by for example gluing. The spine 613 is connected to the inside of the first surface 604 by gluing, stitching, stapling and the like for example.

Each of the sheets of the booklet 612 are of a different size, and the sheet 620, nearest the surface 604 has the largest length, and each subsequent sheet in the booklet 618, 616 and 614 has a shorter length than the previous adjacent sheet, such that the outermost sheet 614 has the shortest length. Thus as the outermost leaf 614 has the shortest length, and each subsequent leaf downstream of the outermost segment 612 has a longer length, and a marginal portion of each of leaves 616, 618 and 620 can be viewed by a user when the booklet is closed, as shown in FIG. 14.

The sheet article 600 shown in FIG. 14A is particularly useful when it is desired to print a map or guide on the concertina folded sheet 610, which map or guide contains detailed street plans or a large quantity of information which may need to be cross referenced. The addition of the booklet 612 on the first surface 604 of the cover 602 enables a key or index of, for example, street names and locations on the concertina material 610 to be located on the sheet article 600, such that a user may open the concertina map or guide 610 and thumb through the key or index on the marginal portions of the booklet 612 and cross-reference the resultant information from the booklet 612 with the map or guide 610 in order to determine where a particular street or location is on the concertina map or guide 610.

As each leaf of the booklet 612 has at least a marginal portion viewable when the booklet 612 is closed, a user is able to read a key or index on the marginal portion, which, for example may correspond to a particular grouping of letters which in turn correspond to street names located on each sheet of the booklet 612. Thus a sheet 614 may have street names being with the letters A to E, and sheet 616 may have street names beginning with the letter F to I, the viewable marginal portion of sheet 616 bearing the code F to I, so that a user knows that those particular street names are on sheet 616. The other sheets may bear the remainder of the street names grouped into particular letters.

In alternative embodiments to that shown in FIG. 14, the booklet 612 may comprise leaves of equal size, such that no marginal portions are visible when the booklet is closed. Alternatively only some of the leaves may be of different sizes so that only some of the leaves display marginal portions. The concertina sheet 610 may have a stiff portion connected to the outermost segment of the folded stack so that a user may grasp the stiff portion upon opening the cover 602 and more easily unfold and fold the sheet 610.

The booklet 612 may alternatively comprise a plurality of separate leaves which are each connected to the cover, but are not connected to each other. Alternatively the booklet 612 may be formed from a plurality of smaller booklets which are connected to the cover. For example the booklet 612 may comprise three separate booklets of three leaves each, wherein each booklet is connected to the cover in an orientation that forms a large booklet of nine leaves.

We turn now to FIG. 15 which shows a sheet article 700 which is similar to the sheet article shown in FIG. 14. Like numerals represent like components. In this embodiment the cover again comprises a first surface 704 and a second surface 706 formed from the same surface and separated by a rotatable fold line 708. The cover 702 includes on the second surface 706 a concertina folded sheet 710. On the first surface 704 the cover 702 has connected to it a sheet material which corresponds to the sheet 502 of FIG. 13A to 13C (minus the stiff cover portion 512).

Again in this embodiment, the sheet material 712 may be folded and unfolded as, described for the embodiment of FIGS. 13A to 13C. The marginal portion of each segment of the sheet material may be printed or connected with information such as a key or index as described above for the embodiment shown in FIG. 14. Thus a user may view the marginal portion of each segment when the sheet 712 is folded into a stack on the cover 704, in order to be able to determine which particular segment bears the desired piece of information thereon. Again the sheet material 712 may contain, for example a key or index to a map or guide, which map or guide may comprise the concertina sheet material 710.

The connection sheet 710 and/or concertina sheet 712 may also comprise a stiff portion on a segment, preferably the outermost segment, of the stack so that a user may more easily grasp and unfold/fold the sheet material.

In alternative embodiments, both the sheet materials of the sheet article 600 or 700 may comprise concertina folded sheet materials, or one material may comprise a folded sheet article not comprising concertina folds. The cover 702 or 602 may comprise securement means which enable the cover to be secured once folded about the fold lines 718 or 608 until needed. The securement means may comprise for example an adhesive tab connected to one edge of the first surface 604 or second surface 606, which, when the surfaces are folded together and flush, may be folded onto the opposite surface and adhered thereto to secure the surfaces together. In alternative embodiments the securement means may comprise press studs or the like on the inside of the first and second surfaces 604, 606, which may be arranged to connect when the surfaces are rotated flush together.

In yet other embodiments of the sheet article shown in FIGS. 14 and 15, the cover 600 or 700 may be formed from two separate surfaces hingedly connected by a hinge or rotatable member for example.

In yet other embodiments, the cover may include a transparent portion on the first surface and/or second surface, which enables viewing of the portion of any attached sheet materials connected to the inside of the first and/or second surfaces. The transparent portion may be in the form of a clear plastic window, or a simple cut-out portion of the cover, for example.

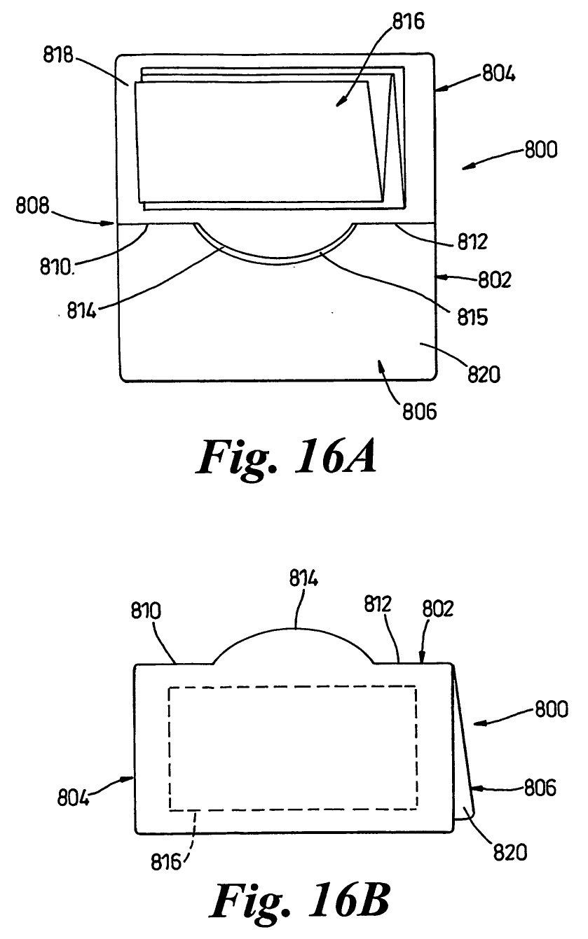

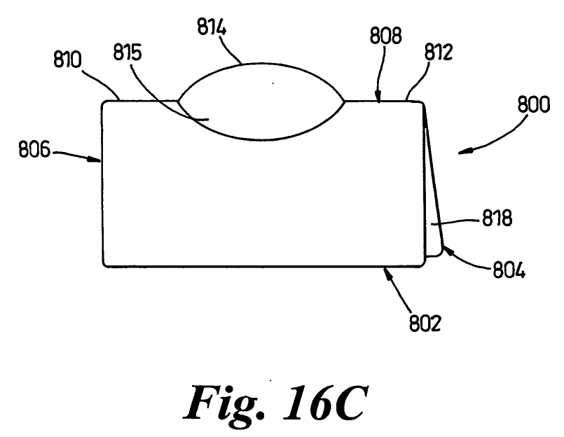

We turn now to FIGS. 16A to 16C which illustrate a preferred embodiment of a sheet article of the eighth aspect of the invention.

Turning firstly to a FIG. 16A, the sheet article 800 comprises a cover 802. The cover 802 comprises a first portion in the form of a first surface 804 and a second portion in the form of a second surface 806, formed from a single surface and rotatably connected by a fold 808. The fold 808 comprises two spaced apart fold lines 810 and 812 which are coaxial, and having a gap between the fold lines.

The first surface 804 comprises on its inside surface 818 a sheet material comprising concertina folds 816.

The second portion 806 comprises a cut-out 815, in the form of a semicircular cut-out section which extends from the free edges of the fold lines 812 and 810 and forms a gap therebetween. The first surface 804 further comprises a handle portion in the form of protruding tab 814, which tab 814 extends across the gap between the fold lines 812 and 810 into the aperture created by cut-out 815 in the second surface 806. Thus the handle portion, when the cover 812 is coplanar, extends through the gap in the rotatable connection 808 into the cut-out 815, creating the effect that the first and second surfaces 804 and 806 comprise a single surface having a rotatable connection therebetween.

We turn now to FIGS. 16B and 16C.

When the cover 802 is folded about the fold lines 810 and 812, as can be seen in FIG. 16B and 16C, the first 804 and second 806 surfaces, rotate towards each other until they are flush, thereby sandwiching the sheet material 816 between the inner surfaces 818 and 820 of the first and second surfaces 804 and 806 respectively.

At the same time, the tab 814 is effected to present out of the cut-out portion 815 of the second surface 806. As can be seen from FIG. 16B and 16C, the tab 814, when the first and second surfaces are substantially flush, extends in the same plane as the first surface 804, and thus protrudes from the first surface 804 past the fold lines 810 and 812, to create an handle portion which may be grasped by a user.

In this way, the sheet article 800 can be folded about the fold lines 810 and 812, to create a substantially credit-card sized article comprising a folded cover 802 which sandwiches the concertina folded material 816. A handle portion in the form of the tab 814 protrudes from the article 800. The sheet article 800 can then be inserted into a wallet or credit-card holder for example, such that the tab 814 protrudes from the opening of the pocket of the wallet or credit-card holder. A user may then easily grasp the tab 814 and remove the sheet article 800 from the wallet or credit-card holder. The tab 814 enables ease of removal of the article 800. Without a handle portion, it can be relatively difficult for a user to remove credit-card sized articles from wallets and credit-card holders, and may result in the pocket in the wallet or credit-card holder becoming damaged due to the need for a user to insert his or her fingers relatively deeply into the pocket.

The use of the tab/cut-out configuration also enables efficient and inexpensive manufacture of the cover 802 utilising only a single sheet of material without needing to connect a separate handle portion to the cover.

In alternative embodiments to that shown in FIGS. 16A to 16C, the sheet article 800 may be provided with a rotatable connection 808 which comprises a single continuous fold line. Connected to the outside of the fold line or on the first or second surface near to the fold line may be a handle portion. In this embodiment, use is effected in the, same way as that described for FIG. 16A to 16C, in that, when the cover 804 is opened to be coplanar, the handle portion will rest against the first surface 804 and/or second surface 806, but when the cover 802 is rotated about the single fold line, the handle portion will be presented protruding in the same plane as either the first or second surface 804 and 806.

In yet further embodiments, the handle portion may be connected to an edge of the first or second surface 804 and 806, rather than at or near the rotatable connection between the two surfaces. In further embodiments the sheet article 800 may comprise further sheet materials connected to the inside of the first and/or second surfaces, which sheet materials may or may not comprise concertina folds. For example a booklet or like may be connected to the inside of the second surface 806. The sheet materials may be as described for any of the aspects of the invention.

The first and/or second surface 804 and 806 may comprise a transparent window or cut-out portion within the surface, which allows information on the sheet article 816 to be viewed through the transparent portion or cut-out.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A sheet material comprising a plurality of folds defining at least four segments, the sheet material being foldable and unfoldable about said folds, the sheet material comprising first and second securement means, arranged in use to cooperate to releasably secure the sheet material in the folded configuration when folded, and wherein the securement means are located such that the sheet material is foldable to a partially folded configuration comprising three columns of segments in a single row in which the first securement means is located on one outer column and the second securement means is located on the other outer column.

2. A sheet material comprising folds defining at least four segments arranged in at least three columns, the sheet material being foldable and unfoldable about said folds, the sheet material further comprising first and second securement means, arranged, in use, to cooperate to releasably secure the sheet material in the folded configuration when folded, the first and second securement means being located on separate columns spaced apart by one column.

3. A sheet material as claimed in claim 1 or 2 wherein the folds preferably comprise a first set of parallel folds.

4-19. (canceled)

20. A method of providing a folded sheet material to a surface, the method comprising the steps of:
a) providing a surface;
b) providing a sheet material of the first aspect of the invention; and
c) in any order, securing the sheet material in a folded configuration and locating the sheet material on the surface.

21. A method as claimed in claim 20 wherein step (c) comprises securing the sheet material in the folded configuration and then locating the secured sheet material on the surface.

22. A method as claimed in claim 20 or 21 wherein step (c) comprises connecting the sheet material to the surface.

23-24. (canceled)

25. A sheet material comprising an envelope portion comprising a pocket and a pocket closure flap; and a sheet portion comprising a first set of folds defining a plurality of segments, detachably connected to the pocket closure flap.

26. A sheet material as claimed in claim 25 wherein the first set of folds is a first set of concertina folds.

27. A sheet material as claimed in claim 25 or 26 wherein the sheet portion is integrally formed with the envelope portion.

28-31. (canceled)

32. A sheet material comprising a first set of parallel folds, defining a plurality of segments, about which folds the sheet material can be unfolded and folded, the first set of folds comprising at least two concertina folds, a plurality of the segments being foldable about said concertina folds to form a stack, and wherein the sheet material comprises at least one segment which, in use, is foldable over the folded stack to form a cover portion thereon.

33. A sheet material as claimed in claim 32 wherein the segment or segments comprising the cover portion effect provision of a solid spine extending substantially along the side of the stack of segments, when the cover portion is folded over the stack, in use.

34-35. (canceled)

36. A sheet material comprising a first set of concertina folds defining a plurality of segments, the sheet material being foldable about the folds to form a stack of segments, and wherein the folds are positioned such that when the segments are folded into a stack, a plurality of the segments present a marginal portion.

37. A sheet material as claimed in claim 36 comprising a first set of concertina folds defining a row of segments, wherein the folds are positioned such that an outermost segment of the row has a first size and a plurality of subsequent segments have a width or length larger than the previous largest upstream segment in a row of segments.

38-40. (canceled)

41. A sheet article comprising a cover and at least two sheet materials fixedly connected to the cover, wherein at least one of the sheet materials comprises concertina folds, and wherein the cover comprises at least a first portion and a second portion arranged in use to enable sandwiching of at least one of the sheet materials between said portions.

42. A sheet article as claimed in claim 41 wherein the sheet materials are connected to different surfaces of the cover.

43-58. (canceled)

59. A sheet article comprising a cover to which is connected a sheet material comprising concertina folds, the sheet material being foldable and unfoldable about said folds, wherein the cover comprises a first portion and a second portion arranged to enable sandwiching of the folded sheet material between said portions, and wherein the cover further comprises a handle portion protruding from the cover.

60. A sheet article as claimed in claim 59 wherein the first and second portions are rotatably connected.

61-66. (canceled)
